(19) United States
(12) Patent Application Publication
(10) Pub. No.: US 2010/0200190 A1
(43) Pub. Date: Aug. 12, 2010

(54) METHOD FOR COOLING AN ENERGY ACCUMULATOR

(76) Inventors: Peter Eckert, Erlangen (DE); Michael Meinert, Erlangen (DE); Karsten Rechenberg, Dormitz (DE)

Correspondence Address: HARNESS, DICKEY & PIERCE, P.L.C., P.O.BOX 8910, RESTON, VA, 20195, US

(21) Appl. No.: 12/680,033

(22) PCT Filed: Sep. 2, 2008
(86) PCT No.: PCT/EP08/61547

§ 371 Date: Mar. 25, 2010

(30) Foreign Application Priority Data
Sep. 27, 2007 (DE) 10 2007 046 368.7

(51) Int. Cl. B60H 1/32

(52) U.S. Cl. 165/41

(57) ABSTRACT

A method is disclosed for cooling an energy accumulator in a rail vehicle, using air. According to at least one embodiment of the invention, the air is fed to the energy accumulator directly from an already cooled or air-conditioned area of the rail vehicle. This occurs in particular when the temperature of the area is lower than the external temperature.

### PRIORITY STATEMENT

This application is the national phase under 35 U.S.C. § 371 of PCT International Application No. PCT/EP2008/061547 which has an International filing date of Sep. 2, 2008, which designates the United States of America, and which claims priority on German patent application number 10 2007 046 368.7 filed Sep. 27, 2007, the entire contents of each of which are hereby incorporated herein by reference.

### FIELD

At least one embodiment of the invention generally relates to a method for cooling an energy accumulator in a rail vehicle with air.

### BACKGROUND

Energy accumulators may be provided in rail vehicles for different purposes. In particular, powerful energy accumulators are necessary in order to be able to operate a rail vehicle, for example a streetcar, without an external supply of energy, at least in certain sections of a route. Sections of a route without an overhead line or power rail are desired if a streetcar is to be routed through a narrow street or through a pedestrian zone.

In an energy accumulator, particularly in a powerful energy accumulator such as is necessary for operating a streetcar, heating of the energy accumulator occurs due to internal power losses. This inputting of heat leads to a shortening of the service life of the energy accumulator.

It has already been proposed to cool an energy accumulator with air or with water. However, such known methods of cooling are not energy-efficient enough if the intention is to cool energy accumulators which are subject to heavy electrical and thermal loading and are intended to serve, for example, for supplying energy to a streetcar on a route which has neither an overhead line nor a power rail.

### SUMMARY

At least one embodiment of the invention is directed to a method for cooling an energy accumulator in a rail vehicle which permits more effective cooling than hitherto.

In at least one embodiment of the invention, the air is fed directly to the energy accumulator from a space in the rail vehicle which has already been cooled or air-conditioned.

### DETAILED DESCRIPTION OF THE EXAMPLE EMBODIMENTS

The method according to at least one embodiment of the invention provides the advantage that the heat which is generated in the energy accumulator is conducted away quickly and reliably because the air which is fed in for the purpose of cooling is at a significantly lower temperature than the ambient air. Due to the better cooling possibility, the efficiency and also the service life of the energy accumulator are advantageously significantly increased. Energy accumulators which are subject to heavier electrical and thermal loading than previous energy accumulators can also advantageously be used.

For example, only if the temperature in the cooled or air-conditioned space is lower than the external temperature is the air from this space fed directly to the energy accumulator. Otherwise, ambient air is fed to the energy accumulator.

This provides the advantage that the coldest available air is always used for cooling.

The cooled or air-conditioned space is, for example, the passenger compartment or the driver's cab in the rail vehicle.

The method according to at least one embodiment of the invention can be used in a streetcar, a rail motor unit or in a locomotive. A rail vehicle here can also be a track-guided vehicle with rubber tires.

The energy accumulator is arranged, for example, in the rail vehicle or outside the rail vehicle.

The energy accumulator is arranged, for example, on the roof or under the floor of the rail vehicle.

For example, the energy accumulator is an electrical energy accumulator such as, for example, a double-layer capacitor.

According to another example, the energy accumulator is an electrochemical energy accumulator, for example a battery. This battery may be, for example, a lead battery, a nickel cadmium battery, a nickel-metal hydride battery or a lithium ion battery.

The energy accumulator can also be a combination of an electrical energy accumulator and an electrochemical energy accumulator.

For example, the energy accumulator is constructed from a plurality of individual cells.

For example, the air is fed to the energy accumulator through an opening in the car body of the rail vehicle. This advantageously ensures that air from the interior of the car body, specifically from a cooled or air-conditioned space which is, for example, either the passenger compartment or the driver's cab, is used to cool the energy accumulators. The opening can be located in the side wall, in the roof or in the floor of the car body.

According to another example, the air is fed to the energy accumulator through an opening in the folding bellows of the rail vehicle. This provides the advantage that the means of feeding through the air, for example a flexible hose, can particularly easily be attached to the folding bellows.

For example, the cooling process is open-loop or closed-loop controlled by a control unit. In this context, advantageously only as much cooling air is extracted from the cooled or air-conditioned space as is absolutely necessary to cool the energy accumulators. The cooling or air-conditioning of the passenger compartment or of the driver's cab is not adversely affected. The expenditure of energy on cooling is advantageously minimized.

For example, the cooling process is open-loop or closed-loop controlled by a plurality of decentralized units of the control unit. The units may be arranged distributed in the vehicle.

For example, the air is fed to a plurality of energy accumulators through just one line. As a result, only a small number of air lines are required. The same cooling air flows through a plurality of energy accumulators in succession.

According to another example, branch lines, which lead to individual energy accumulators of the plurality of energy accumulators, branch off from a main air line.

The plurality of energy accumulators are arranged, for example, in the rail vehicle and/or outside the rail vehicle.

For example, the energy accumulators are arranged on the roof and/or under the floor of the rail vehicle.

The method according to at least one embodiment of the invention provides, in particular, the advantage that the heat which is generated in the energy accumulator is conducted away better than was possible hitherto. This is due to the fact that air which has already been cooled is used.

The improved cooling possibility permits more energy accumulators than hitherto to be installed in the same area. Furthermore, efficiency and the service life of the energy accumulators are significantly increased by the improved cooling.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for cooling an energy accumulator in a rail vehicle with air, comprising:
feeding the air directly to the energy accumulator from a space in the rail vehicle which has already been cooled or air-conditioned.

2. The method as claimed in claim 1, wherein, in the feeding, only if the temperature in the cooled or air-conditioned space is lower than the external temperature is the air from this space fed directly to the energy accumulator, and if not, ambient air is fed to the energy accumulator.

3. The method as claimed in claims 1, wherein the cooled or air-conditioned space is the passenger compartment or the driver's cab.

4. The method as claimed in claim 1, wherein the energy accumulator is arranged in the rail vehicle or outside the rail vehicle.

5. The method as claimed in claim 4, wherein the energy accumulator is arranged on the roof or under the floor of the rail vehicle.

6. The method as claimed in claim 1, wherein the energy accumulator is an electrical energy accumulator.

7. The method as claimed in claim 1, wherein the energy accumulator is an electrochemical energy accumulator.

8. The method as claimed in claim 1, wherein the energy accumulator is a combination_of an electrical energy accumulator and an electrochemical energy accumulator.

9. The method as claimed in claim 1, wherein the energy accumulator is constructed from a plurality of individual cells.

10. The method as claimed in claim 1, wherein the air is fed to the energy accumulator through an opening in the car body of the rail vehicle.

11. The method as claimed in claim 1, wherein the air is fed to the energy accumulator through an opening in the folding bellows of the rail vehicle.

12. The method as claimed in claim 1, wherein the cooling process is open-loop or closed-loop controlled by a control unit.

13. The method as claimed in claim 12, wherein the cooling process is open-loop or closed-loop controlled by a plurality of decentralized units of the control unit.

14. The method as claimed in claim 1, wherein the air is fed to a plurality of energy accumulators through just one line.

15. The method as claimed in claim 1, wherein branch lines, which lead to individual energy accumulators of the plurality of energy accumulators, branch off from a main air line.

16. The method as claimed in claim 14, wherein the plurality of energy accumulators are arranged at least one of in the rail vehicle and outside the rail vehicle.

17. The method as claimed in claim 16, wherein the plurality of energy accumulators are arranged at least one of on the roof and under the floor of the rail vehicle.

18. The method as claimed in claims 2, wherein the cooled or air-conditioned space is the passenger compartment or the driver's cab.

19. The method as claimed in claim 2, wherein the energy accumulator is arranged in the rail vehicle or outside the rail vehicle.
